(19) United States
(12) Patent Application Publication
(10) Pub. No.: US 2010/0233344 A1
(43) Pub. Date: Sep. 16, 2010

(54) PROCESSES FOR PRODUCING LIPID PARTICLES

(76) Inventors: Peter Galuska, Hudson, WI (US); Michael Evenson, Blaine, MN (US); Larry M. Rasmussen, Plymouth, MN (US)

Correspondence Address: GENERAL MILLS, INC., P.O. BOX 1113, MINNEAPOLIS, MN, 55440, US

(21) Appl. No.: 12/722,756

(22) Filed: Mar. 12, 2010

Related U.S. Application Data
(60) Provisional application No. 61/160,034, filed on Mar. 13, 2009.

(51) Int. Cl. A23D 9/00; A23P 1/02

(52) U.S. Cl. 426/601; 426/515

(57) ABSTRACT

The present invention makes particles that are substantially spherical by dispensing globules of an at least partially liquid lipid composition into a liquid bath. The globules can be dispensed by dripping the globules into a liquid bath such that the globules become submerged in the liquid bath and at least partially crystallize into particles. The globules can also be pumped into the liquid bath such that the globules are at least initially submerged within the liquid bath and at least partially crystallize into particles.

### CROSS-REFERENCE TO RELATED APPLICATIONS

This application claims the benefit of priority under 35 U.S.C.119(e)(1) of a provisional patent application Ser. No. 61/160,034, filed Mar. 13, 2009, which is incorporated herein by reference in its entirety.

### FIELD OF THE INVENTION

The present invention relates to making lipid particles that are at least substantially spherical. Such particles can be used, e.g., as a shortening component in food products.

### BACKGROUND OF THE INVENTION

Shortening ingredients that can be used in a dough are well known. Shortening is commonly produced in the form of shortening “chips.” Shortening chips tend to have a relatively flat shape with irregularly shaped edges.

Shortening chips are typically combined with one or more additional dough ingredients and mixed in a manner to form a dough. During mixing the chips tend to break down into smaller sized chips. A problem with many shortening chips however is that, in addition to breaking or fracturing into smaller sized chips, the chips tend to smear or wear away at the edges during dough mixing which can cause such worn away shortening to be finely distributed throughout the dough to an undue degree. Smearing causes the shortening chips to be finely distributed throughout the dough much like an all purpose or dough shortening would be distributed during mixing. Undue smearing or wearing away can cause one or more unintended consequences such as undesirable eating characteristics (e.g., too much “smeared” shortening can cause a biscuit to be too gummy), undesirable dough rising characteristics (e.g., too much “smeared” shortening can cause a biscuit to not rise enough and be relatively flat), and the like. Also, it is noted that although it can be desirable to finely distribute shortening throughout a dough, smearing a chip is a relatively inefficient way of doing so. It is preferred to finely distribute shortening throughout a dough by mixing in an all purpose dough shortening.

It is also known to make shortening pellets. For example, U.S. Pat. No. 6,054,167 (Kincs et al.) discloses a pelletized shortening that is prepared by a process which includes melting, cooling, solidifying and extruding natural and/or synthetic shortening materials to provide shortening pellets or chunks which, without requiring further processing, resist clumping together at least moderate temperatures of about 70° F. (about 21° C.).

U.S. Pat. No. 6,072,066 (Tirtiaux et al.) discloses a process for crystallizing fatty substances for their subsequent fractionation especially by pressure filtering, consisting in particular in melting the fatty substances, dividing the molten mass into beads, feeding these beads into a pre-refrigerated aqueous solution, adjusting the concentration of the fatty substance relative to the aqueous solution, adjusting the feed rate of said beads, adjusting the temperature of the beads/solution mixture, maintaining said mixture temperature until the crystallization of each bead has completely stabilized, subsequently transferring the beads/solution mixture to the filtration location, separating the fatty substance beads under a low pressure from the aqueous solution, and finally extracting from said fatty substance beads, under high pressure, the liquid portion of the fatty substance, and apparatus for applying this process.

Some shortening ingredients have been formed into round-like particles. Such round-like particles have relatively fewer or no corners or edges such that the round-like particles tend to not smear to an undue degree during dough mixing. Such round-like particles are known to be made by spray cooling techniques (referred to as “prilled” particles) or extrusion techniques that include extruding the shortening into ropes and then causing pieces of the rope to be “spheronizied” by tumbling the pieces.

Also, it is known to make certain food products into round-like particles as described in U.S. Pat. No. 5,126,156 (Jones) and U.S. Pat. No. 6,209,329 (Jones et al.).

There is a continuing need for new and improved techniques for making spherical particles that include shortening. For example, some shortening ingredients can be difficult to make into spherical particles because said shortening ingredients have relatively low temperature melt characteristics.

### SUMMARY OF THE INVENTION

The present invention can be used to make lipid particles, preferably particles that are substantially spherical, by dispensing globules of an at least partially liquid composition into a liquid bath. The globules can be dispensed by dripping the globules into a liquid bath such that the globules are in the liquid bath for a period of time to cool and help at least partially crystallize the globules into particles. The globules can also be dispensed into the liquid bath such that the globules are dispensed from an orifice within the liquid bath and remain in the liquid bath for a period of time to cool and help at least partially crystallize the globules into particles. The globules can at least partially crystallize into particles such that the particles can be collected/removed from the liquid bath in a manner that does not substantially deform the particles. The internal portion of the particles may not be fully crystallized when the particles are removed from the liquid bath, but can finish crystallizing internally after being removed from the liquid bath.

Advantageously, methods according to the present invention can form lipid particles using a lipid composition or mixture of lipid compositions that have a relatively low temperature melt characteristic. As another advantage, lipid spheres made according to the present invention can be used in a dough as a shortening ingredient such that the spheres do not smear to an undue degree during mixing. Other advantages include one or more of the following: 1) spheres can be made using relatively simple and inexpensive equipment, 2) a relatively tight particle size distribution can be produced; and 3) relatively higher yields of particles can be obtained for a given amount of fat used.

According to one aspect of the present invention, a method of making a plurality of lipid particles includes the steps of a) dispensing an at least partially liquid lipid composition in a manner to form one or more at least partially liquid globules within a liquid bath, wherein the at least partially liquid lipid composition has a viscosity of 3000 centipoises or less at a temperature in the range of from 68° F.-158° F. (20° C. to 70° C.) for a hold time after melting in the range of from 0 to 24 hours; b) allowing the globules to at least partially crystallize in the liquid bath for a time of less than 60 minutes so as to form a plurality of particles that can be separated from the liquid bath in a manner that substantially maintains the shape of the particles in the liquid bath; and c) separating the particles from the liquid bath.

According to another aspect of the present invention, a method of making a plurality of lipid particles includes the steps of a) pumping an at least partially liquid lipid composition through an orifice in a manner to form one at least partially liquid globule at a time within a liquid bath so as to form a plurality of globules, wherein at least a portion of the orifice is positioned within the liquid bath such that each globule is dispensed directly into the liquid bath from the orifice, and wherein each globule separates from the orifice after the globule is formed due at least to the buoyancy force of the globule within the liquid bath; b) allowing the plurality of globules to at least partially crystallize in the liquid bath for a time of less than 60 minutes so as to form a plurality of particles that can be separated from the liquid bath in a manner that substantially maintains the shape of the particles in the liquid bath; and c) separating the particles from the liquid bath.

According to another aspect of the present invention, a method of making a plurality of lipid particles includes the steps of a) dispensing an at least partially liquid lipid composition in a manner to form a plurality of at least partially liquid globules, wherein the at least partially liquid globules are dispensed into a liquid bath, and wherein the at least partially liquid lipid composition has a viscosity of 3000 centipoises or less at a temperature in the range of from 68° F. to 158° F. (20° C. to 70° C.) for a hold time after melting in the range of from 0 to 24 hours; b) allowing the plurality of globules to at least partially crystallize in the liquid bath for a time of less than 60 minutes so as to form a plurality of particles that can be separated from the liquid bath in a manner that substantially maintains the shape of the particles in the liquid bath; and c) separating the particles from the liquid bath.

According to another aspect of the present invention, an at least substantially spherical lipid particle is made by a method according to the present invention.

### BRIEF DESCRIPTION OF THE DRAWINGS

The advantages of the present invention, and the manner of attaining them, will become more apparent and the invention itself will be better understood by reference to the following description of the embodiments of the invention taken in conjunction with the accompanying drawing, wherein:

FIG. 1 shows a schematic drawing that illustrates a process for making lipid spheres according to one embodiment of the present invention.

FIG. 2 shows a schematic drawing that illustrates a process for making lipid spheres according to an alternative embodiment of the present invention.

### DETAILED DESCRIPTION

The embodiments of the present invention described below are not intended to be exhaustive or to limit the invention to the precise forms disclosed in the following detailed description. Rather the embodiments are chosen and described so that others skilled in the art may appreciate and understand the principles and practices of the present invention.

All publications and patents mentioned herein are incorporated herein by reference in their respective entireties for the purpose of describing and disclosing, for example, the constructs and methodologies that are described in the publications which might be used in connection with the presently described invention. The publications discussed above and throughout the text are provided solely for their disclosure prior to the filing date of the present application. Nothing herein is to be construed as an admission that the inventor is not entitled to antedate such disclosure by virtue of prior invention.

A process according to the present invention includes dispensing an at least partially liquid lipid composition. As used herein, “lipid” refers to any fat-soluble (lipophilic) molecule, such as fats, oils, waxes, cholesterol, sterols, fat-soluble vitamins (such as vitamins A, D, E and K), monoglycerides, diglycerides, phospholipids, and others. One particular lipid, fats (which are also known as triglycerides), are well known and include a wide group of compounds that are generally soluble in organic solvents and largely insoluble in water. In general from a chemical point of view, fats can be described as trimesters of glycerol and fatty acids. Fats can be solid, liquid, or partially liquid at normal room temperature, depending on their structure and composition.

As used herein, an “at least partially liquid lipid composition” means that a limited degree of crystallization may be present with respect to the lipid. However, the “composition” is in a liquid state to a degree such that the composition is fluid and can flow to form “globules” as the composition is passed through an orifice. In certain embodiments, the composition is in a substantially all-liquid state during pumping. As used herein, “globule” (also referred to as a drop, droplet, or bubble) refers to a discrete, individual portion of material that typically has an approximately round or spherical shape. A globule is a precursor to a particle meaning that the shape of a globule can be relatively susceptible to deformation. A globule forms a particle by crystallizing on the surface to a degree such that the particle is relatively less susceptible to deformation as a globule is (e.g., the degree of crystallization permits the particle to be collected from a liquid bath by standard methods so that the particle substantially maintains its shape).

Preferred lipid compositions are those typically used in or with food compositions, especially dough compositions. Exemplary preferred lipid compositions include shortening, margarine, or mixtures thereof. Margarine is well known as a butter substitute and can be made from any of a wide variety of animal and/or vegetable fats, and is oftentimes mixed with other ingredients such as skimmed milk, color, vitamins, emulsifiers, and salt. Shortening is also well known and typically refers to an oil that is made semi-solid at room temperature through the use of more highly saturated oil or through hydrogenation. Shortening has 100% fat content, whereas margarine has a fat content of about 80%. Also, shortening typically does not include salt. A preferred shortening includes partially hydrogenated soybean oil. Exemplary lipid compositions for use in the present invention also include a hydrated fat composition, or mixtures of hydrated fat compositions, as described in co-pending U.S. Publication Number 2008/0175958 (Staeger et al.), wherein the entirety of said publication is incorporated herein by reference for all purposes. Exemplary lipid compositions for use in the present invention also include a hydrated fat piece composition, or mixtures of hydrated fat piece compositions, as described in co-pending U.S. Provisional Patent Application having Ser. No. 61/060,637 (Attorney Docket Number 7042USPRV) by Plank et al. and having a filing date of Jun. 11, 2008, wherein the entirety of said provisional application is incorporated herein by reference for all purposes.

In preferred embodiments, the at least partially liquid lipid composition can include water in an amount of 35 percent or less based on the total weight of the lipid composition.

Preferably, a lipid composition that is used to make particles according to the present invention has a Mettler Dropping Point in the range of from 89.6° F. to 140° F. (32° C. to 60° C.). The Mettler Dropping Point of a lipid composition is the temperature at which the sample will become fluid to flow under the conditions of the test described in AOCS Official Method Cc 18-80 (Reapproved 1997, Revised 2001), wherein the entirety of said test method is incorporated herein by reference for all purposes.

Preferably, an at least partially liquid lipid composition has a viscosity of 3000 centipoises or less at a temperature in the range of from 68° F. to 158° F. (20° C. to 70° C.) for a hold time after melting in the range of from 0 to 24 hours. The viscosity should be measured using a Brookfield LVDV Rheometer with a V-73 spindle at 10 RPM.

According to the invention, a lipid composition is dispensed in a manner to form discrete, individual globules that can cool in a liquid bath so as to help the globules at least partially crystallize and form particles. As used herein, “dispensing” means providing discrete, individual globules to a liquid bath, preferably forming individual globules (droplets) that can be dropped or dripped into the liquid bath or forming individual globules (bubbles) that can be bubbled into the liquid bath. Dispensing according to the present invention is performed at a relatively slow rate and in a controlled manner such that the globules can maintain a shape after being formed such that the globules can at least partially crystallize and form at least substantially spherical particles. Dispensing does not include spraying (e.g., spray cooling to make “prilled” particles). As used herein, “particles” refers to a globule that has undergone at least partially crystallization to a degree such that outer surface of the particle is rigid enough so that the particle can be handled (e.g., collected with other particles) yet substantially maintain its shape.

In order to dispense the composition, the lipid composition is in an at least partially liquid state. In many embodiments, the lipid composition is normally solid at room temperature. Such lipid compositions are melted so that the lipid composition is at least partially liquid and can form into a drop or bubble and then cool in a liquid bath so that the globule crystallizes to a degree such that the globule becomes a particle.

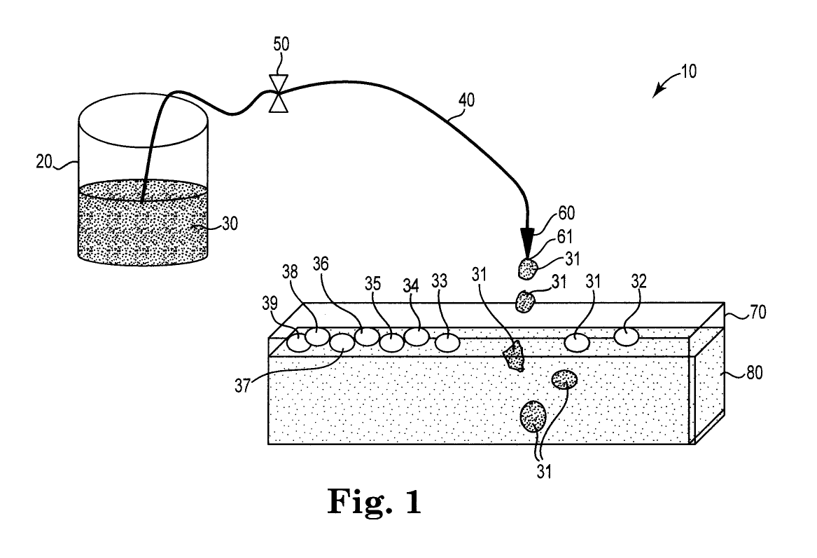

An example of dispensing a composition according to the present invention includes pumping an at least partially liquid lipid composition through an orifice in a manner to form one at least partially liquid lipid globule at a time. Each lipid globule separates from the orifice after the lipid globule is formed and drips into a liquid bath such that the globule can at least partially crystallize and form a particle that can be handled (e.g., collected with other particles) yet substantially maintain its shape. A schematic illustration of such a process is shown in FIG. 1, discussed below. The size of the lipid globule can be controlled to a certain degree by the size (surface area) of the orifice that is being used. In general, for a given composition, flow rate, etc., the diameter of the globule increases as the diameter of the orifice increases. In preferred embodiments where each lipid globule is dripped into a liquid bath, the diameter of the fat globule is in a range of 2 to 6 millimeters.

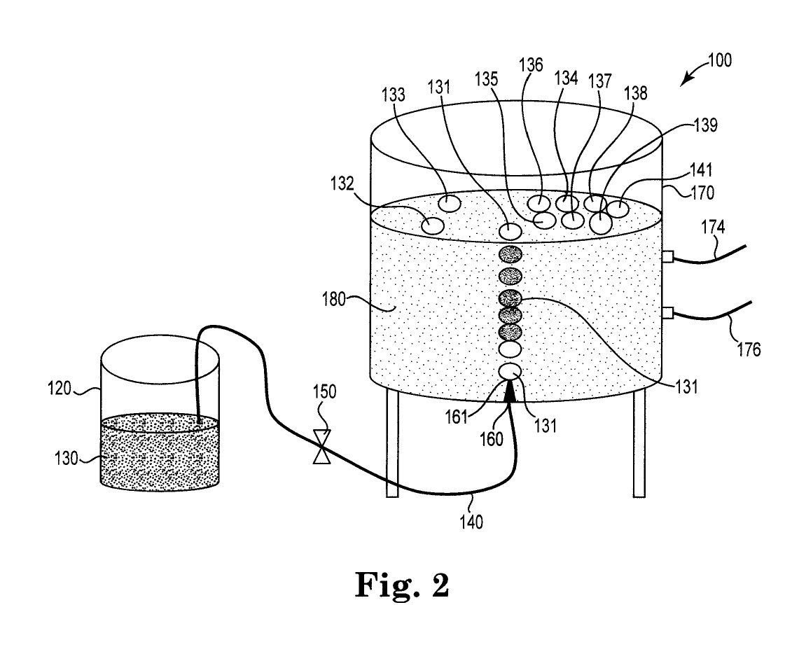

Another example of dispensing a composition according to the present invention includes pumping an at least partially liquid lipid composition through an orifice in a manner to form one at least partially liquid lipid globule at a time, where at least a portion of the orifice is positioned within a liquid bath. Each globule separates from the orifice after the globule is formed such that each globule is dispensed within the liquid bath such that the globule can at least partially crystallize and form a particle that can be handled (e.g., collected with other particles) yet substantially maintain its shape. A schematic illustration of such a process is shown in FIG. 2, discussed below. The size of the lipid globule can be controlled to a certain degree by the rate of pumping. In general, for a given composition, orifice diameter, etc., the diameter of the globule increases as the rate of pumping decreases. In certain embodiments, the size of the lipid globule can be controlled to a relatively lesser degree by the size (surface area) of the orifice that is being used. In general, for a given composition, flow rate, etc., the diameter of the globule increases as the diameter of the orifice increases. In preferred embodiments where each lipid globule is bubbled into a liquid bath, the diameter of the lipid globule is in a range of 1 to 15 millimeters.

After forming the globules, the globules are dispensed into (e.g., dripped into or bubbled within) a liquid bath. A liquid bath is a liquid heat transfer medium that cools the lipid composition so as to allow the lipid to at least partially crystallize and form a particle that can be handled (e.g., collected with other particles) yet substantially maintain its shape. The liquid can also help form and/or maintain the shape of the globules (e.g., through surface tension) as the globules crystallize into particles.

The liquid bath can include any liquid that can function as a suitable heat transfer medium and provide appropriate surface tension between the liquid bath and the composition being formed into particles. Exemplary liquids include water or salt water. In preferred embodiments, a liquid bath for use in the present invention includes water.

Optionally, one or more surfactants can be included in the liquid bath. While not being bound by theory, it is believed that a surfactant helps “soften” the liquid. For example, when dripping a globule into a liquid water bath, the surfactant can help the droplets penetrate the water surface without deforming the droplet to an undue degree. By penetrating the liquid water surface, the globule can become submerged within the liquid bath due to the weight of the globule. In this way, a surfactant can help a process be more robust, especially with respect to temperature. Exemplary surfactants include acetic acid esters of monoglycerides (ACETEM), citric acid esters of monoglycerides (CITREM), diacetyl tartaric acid esters of monoglycerides (DATEM), sorbitan esters, distilled monoglycerides (DMG), mono & diglycerides (MG), lactic acid esters of monoglycerides (LACTEM), monoglycerides, polyglycerol esters, propylene glycol esters of fatty acids, sodium stearoyl lactylate (SSL), calcium stearoyl lactylate (CSL), and lecithins (soy and egg yolk). An exemplary amount of a lecithin surfactant includes 0.1% by weight of water. In certain embodiments, if surfactant is not used, it is preferred that the composition is partially solidified as the globule is being formed.

The temperature of the liquid bath helps control the rate of crystallization of the globules. The temperature of the liquid bath can be in the range of from 32° F. to 68° F. (0° C. to 20° C.), preferably in the range of from 32° F. to 59° F. (0° C. to 15° C.).

Each globule is preferably submerged within the liquid bath (submerge time) and/or allowed to float on the surface of the liquid bath for a time to at least partially crystallize and form a particle that can be handled (e.g., collected with other particles) yet substantially maintain its shape. In preferred embodiments, the globules are allowed to at least partially crystallize in the liquid bath (e.g., at 0° C.) for a time of less than 60 minutes, preferably less than 30 minutes, and even more preferably less than 15 minutes. Preferably, the globules are allowed to at least partially crystallize in the liquid bath for a time in the range of from 1 second to 5 minutes, preferably for a time in the range of from 30 seconds to 3 minutes.

Further crystallization can take place in the internal portion of the particles even after the particles are removed from the liquid bath.

When dripping a globule into a liquid bath, the globule falls through a gaseous medium (e.g., air) and contacts the surface of the liquid bath so as to penetrate the liquid surface and become submerged with the liquid bath. The initial submersion of the globule in the bath helps the globule to crystallize to a degree that is sufficient for the globule to preferably form a substantially spherical particle. In general, dripping a globule into a liquid bath can limit the depth to which the globule becomes submerged because the globule relies on its weight to penetrate and become submerged to a given depth within the bath. Because the depth to which a globule can be submerged is limited in the context of dripping, the temperature of the water bath is preferably kept as cool as possible and the difference in temperature between the liquid globule just before it is dripped into the bath and the liquid bath is preferably kept as low as possible so as to maximize the amount of cooling that takes place while the globule is submerged. For example, in certain embodiments, when “dripping” (see, e.g., FIG. 1) an at least partially liquid lipid composition into a liquid bath, the liquid composition can be pumped at a temperature in the range of from 68° F. to 158° F. (20° C. to 70° C.), preferably at a temperature in the range of from 77° F. to 149° F. (25° C. to 65° C.), and the liquid bath can be at a temperature in the range of from 32° F. to 68° F. (0° C. to 20° C.), preferably from 33.8° F. to 59° F. (1° C. to 15° C.).

When dripping a globule into a liquid bath, to increase the depth to which a globule becomes submerged within the liquid bath (and therefore, the submerge time), the distance (e.g., height) between the drip point and the surface of the liquid bath can be increased. The distance between the drip point and the surface of the liquid bath can be limited because the globule may spread apart to an undue degree upon contact with the liquid surface if the distance is too high. To help prevent the globule from spreading apart to an undue degree, the liquid composition can be partially crystallized such that the globule has a relatively more film/rigid outer surface that can tolerate the increase in impact force upon contacting the liquid surface without spreading apart to an undue degree.

Also, when dripping a globule into a liquid bath, to increase the depth to which a globule becomes submerged within the liquid bath (and therefore, the submerge time) a flow of gas can be dispensed along with the globule in a manner to increase the velocity of the globule as it impacts the surface of the liquid bath. It is noted that, in certain embodiments, using the assistance of a gas flow in such a manner tends to lessen the control on particle size distribution and reduce the average particle size.

As mentioned above, when dripping a globule into a liquid water bath, including a surfactant in the liquid bath can help the droplets penetrate the liquid water surface without deforming the droplet to an undue degree. By penetrating the liquid water surface more easily, the globule can become submerged within the liquid bath to a greater depth.

When bubbling a globule into a liquid bath, the globule forms within the liquid bath, separates from the bubbling orifice, and rises through the liquid bath due to the buoyancy forces of the globule. The submersion of the globule in the bath helps the globule to crystallize to a degree that is sufficient for the globule to preferably form a particle. In general, the depth to which the globule is submerged in bubbling depends on the point at which the globule is bubbled into the liquid bath and the depth of the bath. If the globule is bubbled into the liquid bath near the top of the liquid bath and/or the liquid bath is relatively shallow, the temperature of the water bath is preferably kept as cool as possible and the difference in temperature between the liquid globule just before it is bubbled into the bath and the liquid bath is preferably kept as low as possible so as to maximize the amount of cooling that takes place while the globule is submerged. However, the depth of the liquid bath can be increased and/or the point at which the globule is bubbled into the bath can be selected so that the time that the globule is submerged within the liquid bath is increased such that the temperature of the liquid bath can be increased and/or the temperature difference between the liquid bath and the composition can be increased. For example, in certain embodiments, when “bubbling” (see, e.g., FIG. 2), the liquid composition can be pumped at a temperature in the range of from 68° F. to 230° F. (20° C. to 110° C.) (e.g., at 114° F. (46° C.)), preferably at a temperature in the range of from 140° F. to 221° F. (60° C. to 105° C.), and the liquid bath can be at a temperature in the range of from 32° F. to 68° F. (0° C. to 20° C.), preferably from 32° F. to 59° F. (0° C. to 15° C.).

It is noted that during bubbling, if the liquid bath is too cool and/or the lipid composition is too cool the lipid composition may crystallize to an undue degree in the orifice and the orifice may become plugged. Keeping the orifice unplugged can be managed by one or more of increasing the temperature of the lipid composition as it passes through the orifice (e.g., heating the liquid prior to the orifice and/or heating the orifice) or elevating the temperature of the liquid bath. If the temperature of the liquid bath is increased, the depth of the liquid bath may need to be increased so that the globules are submerged long enough to crystallize to a sufficient level.

Although a surfactant could be included in a liquid bath that is used in the context of bubbling, such a surfactant is not necessary because the globule is formed within the liquid bath and does not need to penetrate the liquid bath surface as it does with respect to dripping.

The shape of a particle made according to the present invention can be quantified so as to help determine whether it is substantially spherical. One such way of quantifying the shape of particles is to determine the average Krumbein shape factor for roundness and sphericity. The Krumbein shape factor is a well-known method of characterizing particle shape. See, e.g., U.S. Pat. No. 6,780,804 (Webber et al.) and U.S. Pat. No. 7,036,591 (Cannan et al.), the entireties of each reference of which are incorporated herein by reference. In general, the Krumbein roundness and sphericity are determined by comparing a particle to standard silhouette profiles on a Krumbein roundness and sphericity chart. As used herein, the phrase “at least substantially spherical” with respect to particle shape means the particle is substantially rounded to form a sphere or oval shaped (or ellipsoid including an oblate ellipsoid) particle. For example, an at least substantially spherical particle according to the present invention has a Krumbein roundness of 0.9 or greater and a Krumbein sphericity of 0.5 or greater. In preferred embodiments, an at least substantially spherical particle according to the present invention has a Krumbein roundness of 0.9 or greater and a Krumbein sphericity of 0.9 or greater.

Particles made according to the present invention can be used in a variety of dough products. For example, lipid spheres made according to the present invention can be used as a shortening component, combined with one or more additional ingredients, and mixed with said ingredients so as to form a biscuit dough, a laminated dough, and the like. Advantageously, lipid spheres made according to the present invention tend to not smear during mixing. As mentioned in the Background section above, smearing or wearing away of fat from a particle during mixing can cause such worn away fat to be finely distributed throughout the dough to an undue degree. Undue smearing or wearing away can cause one or more unintended consequences such as undesirable eating characteristics (e.g., too much “smeared” shortening can cause a biscuit to be too gummy), undesirable dough rising characteristics (e.g., too much “smeared” shortening can cause a biscuit to not rise enough and be relatively flat), and the like.

Methods of reducing smear are also disclosed in the U.S. Provisional Application Ser. No. 61/160,044, titled METHODS OF PREPARING FAT-CONTAINING DOUGH COMPOSITIONS HAVING CONTROLLED FAT SMEAR AND DOUGH COMPOSITIONS MADE THEREFROM by Sherwin et al. having Attorney Docket Number 7191 USPRV and filed on Mar. 13, 2009, wherein the entirety of said provisional patent application is incorporated herein by reference for all purposes.

The shape of particles made according to the present invention may be deformed during dough preparation such that the mass of the particle remains localized. Such localized particle deformation can be acceptable in many instances.

FIG. 1 shows a schematic drawing that illustrates a process for making lipid spheres according to one embodiment of the present invention. The system 10 illustrated in FIG. 1 drips melted droplet 31 into a bath 70 of liquid water 80. In preferred embodiments, a shortening which is in the form of a solid at room temperature is melted so as to provide melted shortening 30 in container 20. Melted shortening 30 is pumped through line 40 via peristaltic pump 50, preferably at a very slow rate so as to produce a discrete, individual globule or droplet 31 at the end of, as shown, a pipette tip 60. The droplet 31 will form at the end 61 of the pipette tip 60 until the weight of droplet 31 can overcome the adhesion forces which can cause droplet 31 to cling to tip 61. After droplet 31 releases from tip 61, the droplet 31 falls into a “cold” liquid water bath 80 that optionally includes a surfactant. As mentioned above, the surfactant appears to “soften” the water so that the droplet 31 can penetrate the cold-water surface and submerge into the liquid bath 80 due to the force of gravity on droplet 31. Submerging droplet 31 into liquid bath 80 helps crystallize droplet 31 into a sphere. Crystallizing causes the melted shortening to change phase from a liquid phase to an at least partially solid phase. Eventually, as shown in FIG. 1, the at least partially crystallized droplet 31 floats to the surface of the water since fat is less dense than water. The plurality of spheres 31, 32, 33, 34, 35, 36, 37, 38, and 39 can be removed from the water bath 80, collected, and dried. The dried fat spheres 31-39 can then be used in a variety of dough products.

FIG. 2 shows a schematic drawing that illustrates a process for making fat spheres according to an alternative embodiment of the present invention. The system 100 illustrated in FIG. 2 forms spheres of fat by bubbling melted shortening into a bath 170 of cold water 180. In preferred embodiments, a shortening which is in the form of a solid at room temperature is melted so as to provide melted shortening 130 in container 120. Melted shortening 130 is preferably pumped at a steady state through line 140 via a peristaltic pump 150 to a pipette tip 160 that is secured inside and on the bottom of tank 170 that is filled with cold water 180. The melted shortening 130 is pumped through the tip 160 such that a discrete, individual bubble 131 of oil can form at the end 161 of tip 160 due to the surface tension between bubble 131 and liquid bath 180. Bubble 131 forms until the buoyancy force of bubble 131 overcomes the adhesion force between bubble 131 and end 161. After bubble 131 is separated from the end 161 by the buoyancy force of bubble 131, bubble 131 can then float up through the cold water 180 so as to cool the bubble 131 in a manner that causes bubble 131 to at least partially crystallize. As shown, coolant supply line 174 and coolant return line 176 allow a coolant to be used to maintain the water 180 at a cool temperature. The plurality of spheres 131, 132, 133, 134, 135, 136, 137, 138, 139, and 141, can be removed from the water bath 180, collected, and dried. The dried fat spheres 131-139, and 141 can then be used in a variety of dough products. In certain instances, it has been observed that a method utilizing the system 100 illustrated in FIG. 2 can produce fat spheres at a much higher rate than a method utilizing the system 10 illustrated in FIG. 1.

### EXAMPLES

### Example 1

The following equipment and conditions were used in to produce shortening spheres in the 3.5-4.5 mm size range.

The shortening used was a partially hydrogenated soybean oil flake obtained from Golden Brands, LLC, Louisville, Ky., under the trade name LP 417 Soft Flake.

The tank arrangement was similar to that shown in FIG. 2. A stainless steel tank with a diameter of 40 cm and a height of 51 cm was filled to a depth of 45 cm with “tap water”. The temperature of the water was 57° F.-59° F. (13.9° C.-15° C.). The 2-inch drain on the tank was capped with a stainless steel plug, which had a ¼ inch threaded hole in the middle of it. Screwed into the hole (one from the inside and one from the outside of the cap) were 2 brass ¼ inch Inserts X ¼ inch MIP fittings. Attached to the fitting running to the inside of the tank was a 1300 microliter polypropylene pipette tip (tip having product number 25711-50 from Cole Parmer®, Vernon Hills, Ill.). The top of the tip was cut off leaving a tip orifice of 2 mm.

The fitting running to the outside of the tank was connect to a 7 cm section of ¼ inch tubing obtained from Nalgene®, Rochester, N.Y., which was connected to 22 cm of Masterflex® 06419-16 Tygon® tubing (0.12 inch I.D.) which was in turn connected to a 183 cm section of Masterflex® 06419-14 Tygon® tubing (0.06 inch I.D.) Reducing barbs were used to connect the tubing sections. The Masterflex® 06419-14 Tygon® tubing (0.06 inch I.D) was threaded through the Masterflex® Easy Load 3 peristaltic pump head (77800-50) and which was powered by a Masterflex® Console Drive (Model 77521-40).

200-300 g of shortening was melted in a microwave to a temperature of 200° F.-210° F. (93.3° C.-98.9° C.). This shortening was than pumped at a rate of approximately 66 g/minute (setting of 10.00 on the speed dial on the console) through the hosing into the tank of water (via the pipette tip). Small clear spheres would be forced rapidly from the tip, and would float to the surface of the water (taking 3-7 seconds depending on agitation). These spheres cooled as they rose to and floated on the surface of the water. Some gentle manual agitation with a rubber spatula was used at the surface of the water to help prevent the spheres from sticking to each other before they were suitably solidified on the outer surface. After approximately 5 minutes the spheres had become opaque (which indicated suitable solidification); the particles were then skimmed off of the surface of the water with a wire sieve, and allowed to air dry.

Other embodiments of this invention will be apparent to those skilled in the art upon consideration of this specification or from practice of the invention disclosed herein. Various omissions, modifications, and changes to the principles and embodiments described herein may be made by one skilled in the art without departing from the true scope and spirit of the invention.

1. A method of making a plurality of lipid particles, the method comprising the steps of:
a) dispensing an at least partially liquid lipid composition in a manner to form one or more at least partially liquid globules within a liquid bath, wherein the at least partially liquid lipid composition has a viscosity of 3000 centipoises or less at a temperature in the range of from 68° F. to 158° F. (20° C. to 70° C.) for a hold time after melting in the range of from 0 to 24 hours;
b) allowing the globules to at least partially crystallize in the liquid bath for a time of less than 60 minutes so as to form a plurality of particles that can be separated from the liquid bath in a manner that substantially maintains the shape of the particles in the liquid bath; and
c) separating the particles from the liquid bath.

2. The method of claim 1, wherein the globules are allowed to at least partially crystallize in the liquid bath for a time of less than 30 minutes.

3. The method of claim 1, wherein the globules are allowed to at least partially crystallize in the liquid bath for a time in the range of from 1 second to 5 minutes.

4. The method of claim 1, wherein the step of dispensing comprises the steps of:
a) providing a source of the at least partially liquid lipid composition; and
b) pumping the at least partially liquid composition through an orifice in a manner to form one at least partially liquid globule at a time, wherein each globule separates from the orifice after the globule is formed, and wherein at least a portion of the orifice is positioned within the liquid bath such that each globule is dispensed directly into the liquid bath from the orifice.

5. The method of claim 4, wherein the liquid bath comprises water at a temperature in the range of from 32° F. to 59° F. (0° C. to 15° C.) and, just prior to the step of dispensing, the at least partially liquid lipid composition is at a temperature in the range of 68° F. to 230° F. (20° C. to 110° C.).

6. The method of claim 4, wherein the liquid bath comprises water and surfactant.

7. The method of claim 1, wherein the at least partially liquid lipid composition comprises water in an amount of 35 percent or less based on the total weight of the at least partially liquid lipid composition.

8. The method of claim 1, wherein the at least partially liquid lipid composition is a shortening composition.

9. The method of claim 1, wherein the at least partially liquid lipid composition is a margarine composition.

10. The method of claim 1, wherein the at least partially liquid lipid composition is a mixture of a shortening composition and a margarine composition.

11. The method of claim 1, wherein the at least partially liquid lipid composition has a Mettler Dropping Point value in the range of from 89.6° F. to 140° F. (32° C. to 60° C.).

12. A method of making a plurality of lipid particles, the method comprising the steps of:
a) pumping an at least partially liquid lipid composition through an orifice in a manner to form one at least partially liquid globule at a time within a liquid bath so as to form a plurality of globules, wherein at least a portion of the orifice is positioned within the liquid bath such that each globule is dispensed directly into the liquid bath from the orifice, and wherein each globule separates from the orifice after the globule is formed due at least to the buoyancy force of the globule within the liquid bath;
b) allowing the plurality of globules to at least partially crystallize in the liquid bath for a time of less than 60 minutes so as to form a plurality of particles that can be separated from the liquid bath in a manner that substantially maintains the shape of the particles in the liquid bath; and
c) separating the particles from the liquid bath.

13. A method of making a plurality of lipid particles, the method comprising the steps of:
a) dispensing an at least partially liquid lipid composition in a manner to form a plurality of at least partially liquid globules, wherein the at least partially liquid globules are dispensed into a liquid bath, and wherein the at least partially liquid lipid composition has a viscosity of 3000 centipoises or less at a temperature in the range of from 68° F. to 158° F. (20° C. to 70° C.) for a hold time after melting in the range of from 0 to 24 hours;
b) allowing the plurality of globules to at least partially crystallize in the liquid bath for a time of less than 60 minutes so as to form a plurality of particles that can be separated from the liquid bath in a manner that substantially maintains the shape of the particles in the liquid bath; and
c) separating the particles from the liquid bath.

14. The method of claim 13, wherein the particles further crystallize internally after the step of separating the particles from the liquid bath.

15. The method of claim 14, wherein the step of dispensing comprises the steps of:
a) providing a source of the at least partially liquid lipid composition; and
b) pumping the at least partially liquid composition through an orifice in a manner to form one at least partially liquid globule at a time, wherein each globule separates from the orifice after the globule is formed, and wherein at least a portion of the orifice is positioned within the liquid bath such that each globule is dispensed directly into the liquid bath from the orifice.

16. The method of claim 15, wherein the liquid bath comprises water at a temperature in the range of from 32° F. to 59° F. (0° C. to 15° C.) and the source of the at least partially liquid lipid composition is at a temperature in the range of 68° F. to 230° F. (20° C. to 110° C.).

17. The method of claim 15, wherein the liquid bath further comprises a surfactant.

18. The method of claim 13, wherein the step of dispensing comprises the steps of
a) providing a source of an at least partially liquid lipid composition; and
b) pumping the at least partially liquid lipid composition through an orifice in a manner to form one at least partially liquid globule at a time, wherein each globule separates from the orifice after the globule is formed and drips into the liquid bath.

19. The method of claim 18, wherein each globule separates from the orifice due to at least the weight of the globule.

20. The method of claim 18, wherein the liquid bath comprises water at a temperature in the range of from 32° F. to 59° F. (0° C. to 15° C.) and the source of the at least partially liquid lipid composition is at a temperature in the range of 68° F. to 158° F. (20° C. to 70° C.).

21. The method of claim 20, wherein the liquid bath further comprises a surfactant.

22. An at least substantially spherical lipid particle made by the method of claim 1.

23. The particle of claim 22, wherein the particle has a Krumbein roundness of 0.9 or greater and a Krumbein sphericity of 0.5 or greater.

24. The particle of claim 23, wherein the particle has a Krumbein roundness of 0.9 or greater and a Krumbein sphericity of 0.9 or greater.
